(19) United States
(12) Patent Application Publication
(10) Pub. No.: US 2011/0247178 A1
(43) Pub. Date: Oct. 13, 2011

(54) HINGE DEVICE FOR A TOOLBOX

(76) Inventor: Shao-Hsien Hsu, Taichung County (TW)

(21) Appl. No.: 12/758,020

(22) Filed: Apr. 11, 2010

(51) Int. Cl. E05D 5/14

(52) U.S. Cl. 16/386

(57) ABSTRACT

A hinge device for a toolbox having a first shell and a second shell includes a first opening defined in the first shell and a second opening defined in the second shell. Two first protrusions are respectively formed on two opposite lateral surfaces of the first opening. Two second protrusions are respectively formed on two opposite lateral surfaces of the second opening. A hinge member is pivotally accommodated in the first and second opening. The hinge member has two pairs of grooves respectively defined in two ends thereof for correspondingly and pivotally engaging with the two first protrusions and the two second protrusions.

### BACKGROUND OF THE INVENTION

1. Field of the Invention

The present invention relates to a hinge device for a toolbox, and more particularly to a hinge device which is disposed on the toolbox to make the toolbox openable.

2. Description of Related Art

As shown in FIG. 7, a conventional hinge device for a toolbox 10 has an upper casing 11 and a lower casing 12 which is hinged to the upper casing 11. The upper casing 11 in accordance with the prior art comprises two first protrusions 111 horizontally formed on and extending from an outer side of the upper casing 11. Each first protrusion 111 has a pivot 112 axially extending from one end thereof. The two pivots 112 are in a face-to-face manner. The lowing casing 12 has a second protrusion 121 formed on and extending from an outer side thereof. The second protrusion 121 has two holes 122 axially defined in two opposite ends thereof for respectively and pivotally engaging with the two pivots 112. Therefore, the upper casing 11 and the lower casing 12 are pivotally rotatable relative to each other when the two pivots 112 respectively engage with the two holes 122.

However, the conventional hinge device has several disadvantages. Firstly the toolbox 10 can not be freely placed in a standing position due to the hinge device extending from the outer surfaces of the upper casing 11 and the lower casing 12. Secondly, when manufacturing the upper and lower casings 11, 12, the fabrication of the two first protrusions 111 and the second protrusion 121 would require much time and work. Therefore, the conventional hinge device is inconvenient to be used and fabricated.

The present invention has arisen to mitigate and/or obviate the disadvantages of the conventional hinge device for a toolbox.

### SUMMARY OF THE INVENTION

The main objective of the present invention is to provide an improved hinge device for a toolbox.

To achieve the objective, the hinge device for a toolbox having a first shell and a second shell in accordance with the present invention includes a first opening defined in and extending through a wall of the first shell and a second opening defined in and extending through a wall of the second shell.

Two first protrusions are respectively formed on and extend from two opposite lateral surfaces of the first opening. A first gap is defined in between each first protrusion and a bottom surface of the first opening. Two second protrusions are respectively formed on and extend from two opposite lateral surfaces of the second opening. A second gap is defined in between each second protrusion and a bottom surface of the second opening.

A hinge member is pivotally accommodated in the first and second openings. The hinge member has two pairs of grooves respectively defined in two ends thereof for correspondingly and pivotally engaging with the two first protrusions and the two second protrusions.

Therefore, when assembling, the first shell is pivotally hinged to the second shell, and the toolbox is able to be opened/closed by pivotally rotating the first and second shells.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a hinge device for a toolbox in accordance with the present invention;

FIG. 2 is an assembled perspective view of the hinge device for a toolbox in accordance with the present invention as the toolbox is in a closed state;

FIG. 3 is an assembled perspective view of the hinge device for a toolbox in accordance with the present invention as the toolbox is in an open state;

FIG. 4 is a partially cross-sectional view of the hinge device for a toolbox in accordance with the present invention taken along line C-D in FIG. 3, which shows a hinge device;

FIGS. 5-6 are partially cross-sectional views of the hinge device for a toolbox in accordance with the present invention taken along line A-B in FIG. 2; and

FIG. 7 is a perspective view of a conventional hinge device for a toolbox in accordance with the prior art.

### DETAILED DESCRIPTION OF THE INVENTION

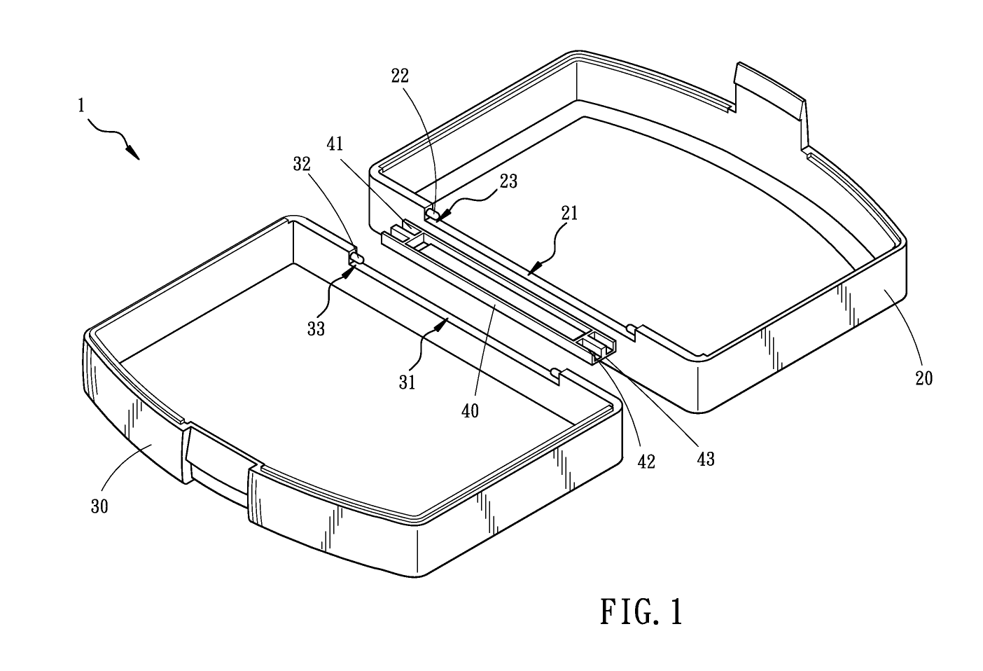

Referring to the drawings and initially to FIGS. 1-3, a hinge device for a toolbox in accordance with the present invention is illustrated. The hinge device is disposed on the toolbox 1. The toolbox 1 comprises a first shell 20 and a second shell 30 which are pivotally rotatable with respect to each other via the hinge device. The hinge device comprises a first opening 21 which is defined in and extends through a wall of the first shell 20 and a second opening 31 which is defined in and extends through a wall of the second shell 30. The first opening 21 and the second opening 31 have a substantially same size.

Two first protrusions 22 are respectively formed on and symmetrically extend from two opposite lateral surfaces of the first opening 21. A first gap 23 is defined in between each first protrusion 22 and a bottom surface of the first opening 21. Two second protrusions 32 are respectively formed on and symmetrically extend from two opposite lateral surfaces of the second opening 31. A second gap 33 is defined in between each second protrusion 32 and a bottom surface of the second opening 31.

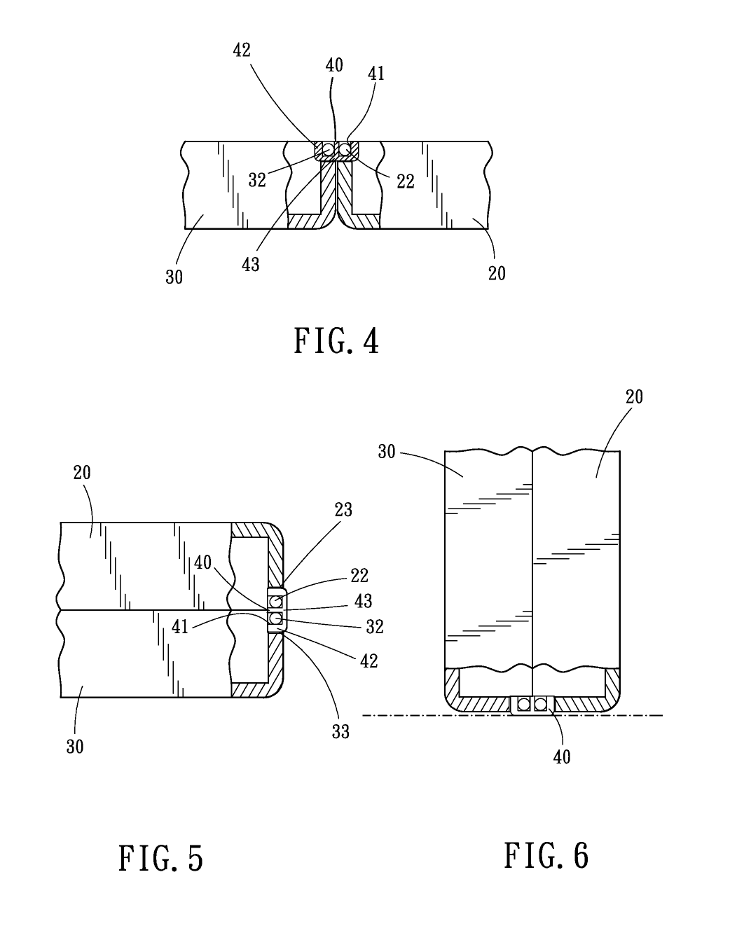

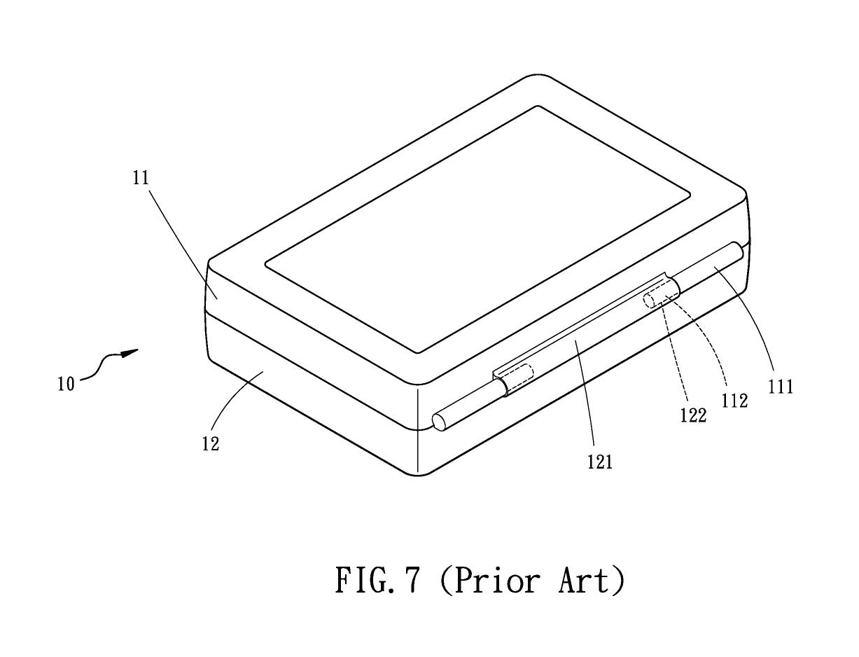

A hinge member 40 is an elongated plate and corresponds to the first and second openings 21, 31 in shape for pivotally accommodating in the first and second openings 21, 31. The hinge member 40 has two opposite ends. Each end of the hinge member 40 has three parallel walls 42 longitudinally formed thereon and a primary wall 43 perpendicularly connected to the three parallel walls 42. The three walls 42 and the primary wall 43 define a pair of grooves 41 therebetween. The two pairs of grooves 41 are provided for correspondingly and pivotally engaging with the two first protrusions 22 and the two second protrusions 32. As shown in FIGS. 4-5, two opposite walls of the three parallel walls 42 and the primary wall 43 in each end of the hinge member 40 are respectively correspond to a size of each first and second gap 23, 33, such that each of the two first protrusions 22 and the two second protrusions 32 is pivotally restricted in the corresponding groove 41.

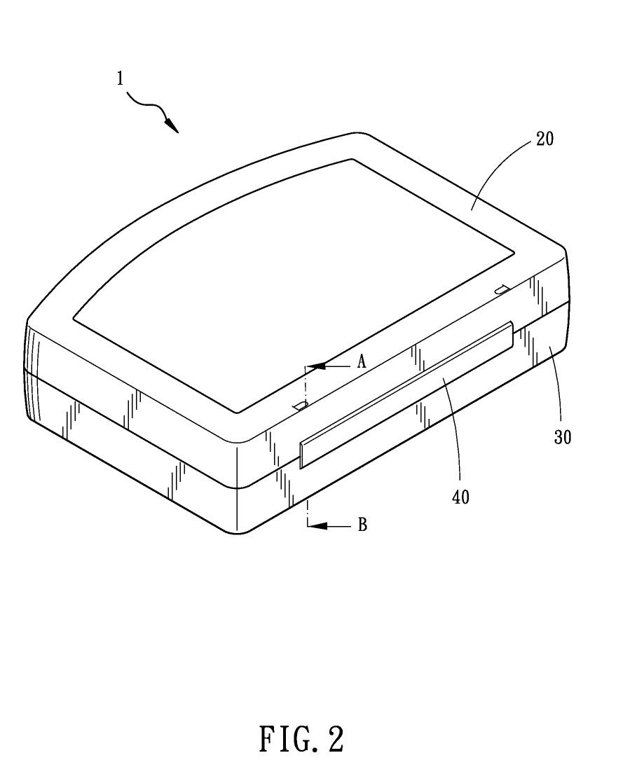

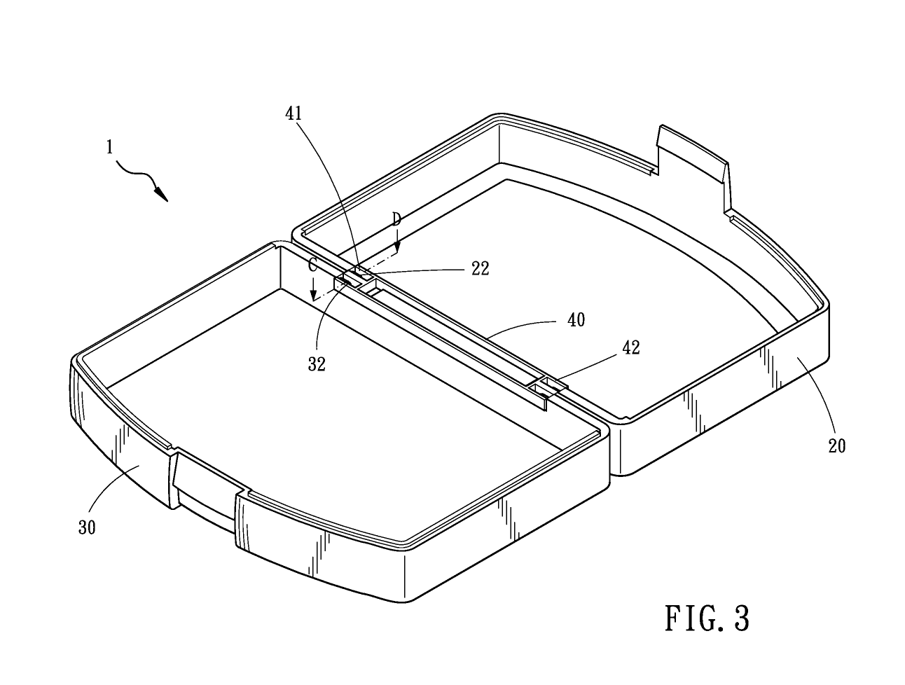

Therefore, as shown in FIGS. 2-3, the first shell 20 and the second shell 30 of the toolbox 1 are pivotally rotatable with respect with each other to respectively make a closed state and an open state of the toolbox 1. And when the toolbox 1 is in the open/closed state, the hinge member 40 is unprotruded from the wall of the toolbox 1. As shown in FIG. 6, when the toolbox 1 is in the closed state, the toolbox 1 is able to be placed stably in a standing position in which the wall of the toolbox 1 with the hinge member 40 contacts the ground or a desk.

Although the invention has been explained in relation to its preferred embodiment, it is to be understood that many other possible modifications and variations can be made without departing from the spirit and scope of the invention as hereinafter claimed.

What is claimed is:

1. A hinge device for a toolbox having a first shell and a second shell, characterized in that the hinge device is disposed between the first shell and the second shell and comprises:
a first opening defined in and extending through a wall of the first shell, a second opening defined in and extending through a wall of the second shell;
two first protrusions respectively formed on and extending from two opposite lateral surfaces of the first opening, a first gap defined in between each first protrusion and a bottom surface of the first opening, two second protrusions respectively formed on and extending from two opposite lateral surfaces of the second opening, a second gap defined in between each second protrusion and a bottom surface of the second opening; and
a hinge member pivotally accommodated in the first and second openings, the hinge member having two pairs of grooves respectively defined in two ends thereof for correspondingly and pivotally engaging with the two first protrusions and the two second protrusions;
wherein when assembling, the first shell is pivotally hinged to the second shell via the hinge member and the toolbox is able to be opened/closed by pivotally rotating the first and second shells.

2. The hinge device for a toolbox as claimed in claim 1, wherein the hinge member has two opposite ends, each end of the hinge member having three parallel walls longitudinally formed thereon and a primary wall perpendicularly connected to the three parallel walls, the pair of grooves respectively located between the three walls and the primary wall, two opposite walls of the three parallel walls and the primary wall in each end of the hinge member respectively corresponding to a size of each first and second gap such that each of the two first protrusions and the two second protrusions is pivotally restricted in the corresponding groove.
